(19) United States
(12) Patent Application Publication
(10) Pub. No.: US 2017/0082554 A1
(43) Pub. Date: Mar. 23, 2017

(54) HIGH SPEED, FLEXIBLE PRETREATMENT PROCESS MEASUREMENT SCANNER

(71) Applicant: FORD GLOBAL TECHNOLOGIES, LLC, Dearborn, MI (US)

(72) Inventor: Thomas Dougan, Northville, MI (US)

(21) Appl. No.: 14/857,272

(22) Filed: Sep. 17, 2015

(51) Int. Cl. G01N 21/88

(52) U.S. Cl. CPC G01N 21/8851; G01N 21/8806; G01N 2021/8864; G01N 2021/845

(57) ABSTRACT

An imaging system for detecting a defect on a workpiece surface includes one or more independently operating imaging modules and a control system including one or more processors having non-transitory computer-readable instructions for receiving and processing digital data of images captured by the one or more imaging modules to provide a combined image of a portion of the workpiece surface. The independently operating imaging modules each include a lighting unit having an adjustable support frame carrying a plurality of indexing light sources and an imaging unit including one or more imagers carried by the support frame. The imaging unit includes a pair of imagers disposed on the adjustable support frame to capture one or more images of a portion of the workpiece surface. Imaging modules for use in the imaging system, and methods for scanning a portion of a workpiece by the imaging system are described.

### TECHNICAL FIELD

This disclosure relates to devices and methods for inspecting and detecting defects in a portion of a surface of a workpiece. In particular, the disclosure relates to devices and methods for identifying pretreatment process defects in a workpiece such as a vehicle body panel.

### BACKGROUND

During the manufacturing process, vehicle body panels are subjected to a variety of pretreatment processes including without intending any limitation welding, sanding, heating/baking, and others. Each of these processes can leave or create defects in a body panel surface, such as welding residue, sanding residue, scratches, dings, dents, oven residue, dirt specks, fibers/hair, and others. Such surface defects present a significant quality concern for overall appearance of a finished vehicle.

To identify and reduce the incidence of such pretreatment process defects, vehicle manufacturers have considered a variety of solutions for identifying and/or quantifying such defects, ranging from simple visual inspection to very complicated automated inspection machines. These machines are used to identify defects and their sources, allowing reduction in the number of vehicles so affected.

Flexibility is a significant problem with conventional vehicle surface inspection machines. Because of their size and complexity, the locations at which such machines can be implemented in a manufacturing facility are limited. In turn, transferring such machines from a first location, for example a location on a conveyer, to a second location in the same manufacturing facility (for example a different location on the conveyer or a different area of the facility) may not be possible.

Thus, a need is identified in the art for improvements to inspection systems and methods for workpiece surfaces such as vehicle body panels.

### SUMMARY

In accordance with the purposes and benefits described herein and to solve the above-summarized and other problems, in one aspect an imaging module for detecting a defect on a workpiece surface is described, comprising a lighting unit comprising an adjustable support frame carrying a plurality of indexing light sources and an imaging unit including one or more imagers carried by the support frame. In embodiments, the imaging unit may include a pair of imagers disposed on the adjustable support frame to capture one or more images of a portion of the workpiece surface. The indexing light sources comprise a plurality of light sources arrayed in a coplanar orientation. The support frame may be configured to rotate about one or more axes to alter an angle of incidence of light emitted by the lighting unit relative to the workpiece surface.

In another aspect, an imaging system for detecting a defect on a workpiece surface includes one or more independently operating imaging modules as described above and a a control system comprising one or more processors comprising non-transitory computer-readable instructions for receiving and processing digital data of images captured by the one or more imaging modules to provide a combined image of a portion of the workpiece surface. In embodiments, the control system further includes a positioning imager for determining an initial position of the workpiece surface. A conveyer for transporting the workpiece past the one or more independently operating imaging modules may be included. In other embodiments, the control system further includes a workpiece position sensor associated with the conveyer, the position detector being configured for transmitting real-time workpiece position data to the control system. One or more light sensors may be provided for determining an intensity of light emitted from the one or more imaging modules and reflecting from the workpiece surface.

In embodiments, the one or more independently operating imaging modules are configured for scanning of a portion of a static workpiece surface. In other embodiments, the one or more independently operating imaging modules are configured for dynamic scanning of a portion of the workpiece surface in motion.

In yet another aspect, methods are described for detecting a defect on a workpiece surface including steps of scanning a portion of the workpiece surface, obtaining digital data representing a plurality of images of the scanned portion, combining the digital data to provide a fused image of the portion of the workpiece surface, and comparing the fused image to a reference image of the portion of the workpiece surface. The scanning may be accomplished by providing a relative motion between the workpiece surface and one or more independently operating imaging modules as described above. In embodiments, the relative motion is provided by one or both of translating the one or more independently operating imaging modules over the workpiece surface and translating the workpiece surface past the one or more independently operating imaging modules, such as by a conveyer.

The described methods further include a step of identifying dark pixels in the fused image and classifying said dark pixels as defects in the workpiece surface. In embodiments, the comparing is to a reference image provided by a high definition CAD drawing combined with digital data of captured images of a reference similar workpiece surface portion.

In the following description, there are shown and described embodiments of the systems, devices, and methods for identifying defects in a portion of a workpiece surface such as a vehicle body component. As it should be realized, the systems, devices, and methods are capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed sun visor, and together with the description serve to explain certain principles thereof. In the drawing:

FIG. 1 shows an imaging module according to the present disclosure;

FIG. 2 depicts a representative placement of imaging modules for vertical scanning of a portion of a vehicle body;

FIG. 3 depicts representative placements of imaging modules for horizontal scanning of a portion of a vehicle body;

FIG. 4 depicts a side view of an embodiment of an imaging system for scanning a portion of a vehicle body surface;

FIG. 5 depicts a rear view of the imaging system of FIG. 4; and

FIG. 6 presents in flowchart form a method for detecting defects in a portion of a workpiece surface according to the present disclosure.

Reference will now be made in detail to embodiments of the disclosed systems, devices, and methods for identifying defects in a portion of a workpiece surface, examples of which are illustrated in the accompanying drawing figures.

### DETAILED DESCRIPTION

At a high level, the present disclosure provides devices, systems, and methods for automated inspection of workpiece surfaces such as vehicle bodies/body panels disposed on a moving conveyer for surface defects, for example for inspection of such workpieces after one or more pretreatment processes involved in the vehicle manufacture/assembly process. Exemplary, though non-limiting, examples of pretreatment processes include heating/baking processes, sanding processes, welding processes, and others. Non-limiting examples of surface defects include welding residue, sanding residue, oven residue, scratches, dings, dents, dirt specks, fibers/hair, surface discolorations, part misalignment, and others.

As will be appreciated by consideration of the present disclosure, the described devices, systems, and methods are adaptable for implementation at any station of a vehicle manufacture/assembly process, and indeed further the devices and systems can be transported between one or more stations of the assembly process as needed. This provides a significant advantage compared to other monolithic systems used in modern automotive assembly plants which, due to their size, cannot economically be disassembled. Indeed, should such monolithic systems have to be moved it is often no less costly to simply construct new systems at the desired location rather than move the existing system.

The presently described systems and methods rely on inspection of a portion of a workpiece surface such as portions of key areas of a vehicle body (hood panel, roof panel, door panel, fender panel, etc.) rather than requiring analysis of the entire vehicle body surface as is the case for conventional automated inspection systems requiring costly, complicated equipment for determining exact size and location of surface defects. Different key areas may be predetermined for different vehicle body configurations/styles. By the described systems, devices, and methods, high repeatability and reproducibility for surface detection on such key areas are achieved, along with real-time transmission of inspection data.

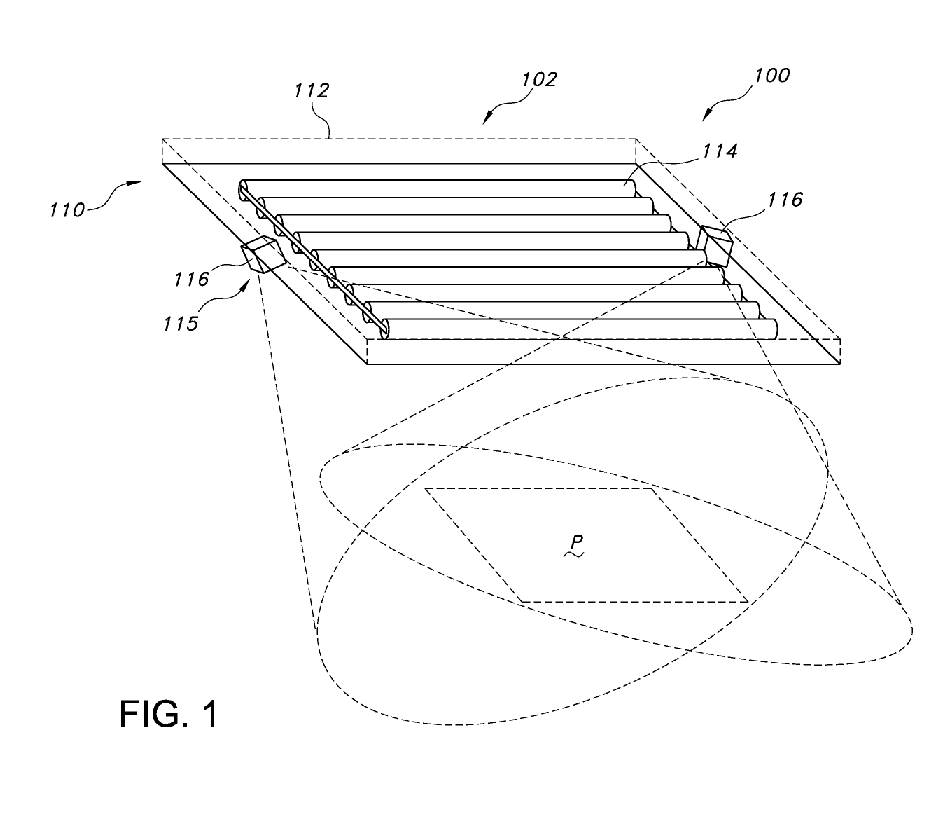

To implement the systems and methods, an imaging system 100 is provided comprising one or more independently operating imaging modules 102 for acquiring multiple images of the portion of the workpiece surface to be inspected. With reference to FIG. 1, in one embodiment an imaging module 102 includes a lighting unit 110 comprising an adjustable support frame 112 (shown generically as a rectangular frame in the embodiment) carrying a plurality of indexing light sources 114 and an imaging unit 115 comprising one or more imagers 116. The light sources 114 may be arrayed in a coplanar orientation as shown. In the depicted embodiment, the imaging module 102 comprises a pair of imagers 116 oriented to provide views (note the fields of view of imagers 116 shown in broken lines) of a portion P of a workpiece such as a vehicle body panel (not shown in this view) illuminated by the plurality of indexing light sources 114. An adjustable support frame 112 is provided that can rotate or pivot about one or more axes in order to alter an angle of incidence of light emitted by the lighting unit 110 and the fields of view of the imagers 116. Typically an imaging unit 115 is operatively associated with a lighting unit 110 to function as a unit.

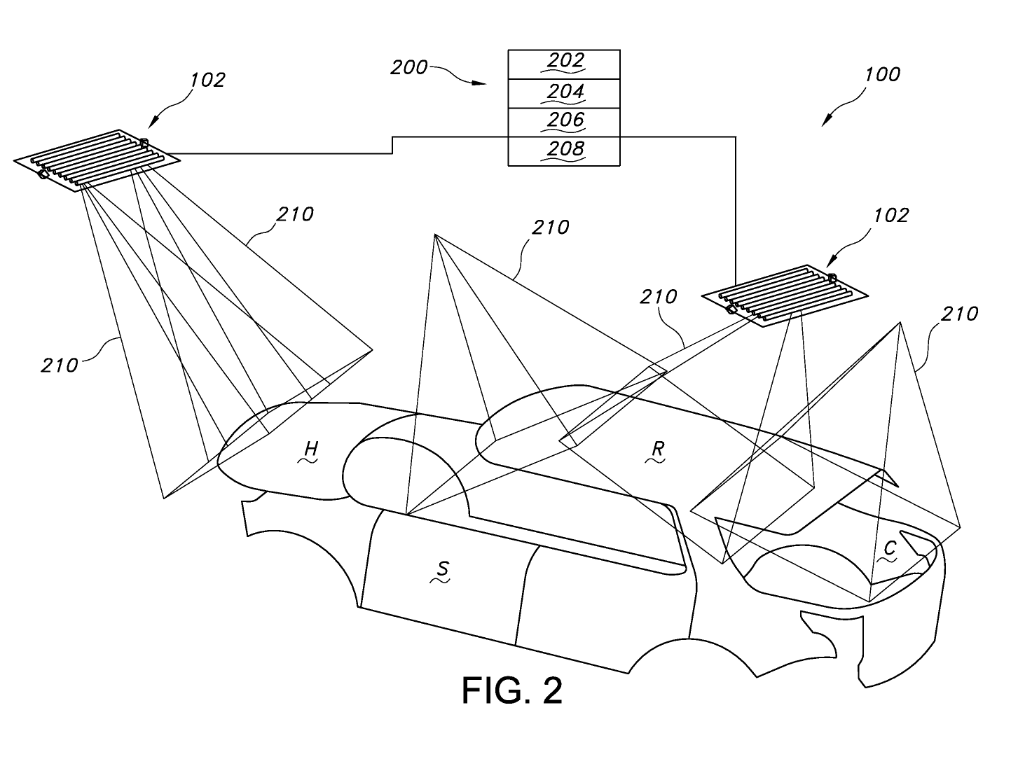

The imaging module 102 may be operatively connected to a control system generically represented in FIG. 2 as controller 200. Controller 200 may include one or more suitable processors for receiving and processing image data from the imagers 116, and further for controlling operation of imagers 116, lighting units 110, etc. As is known in the art for automation of manufacturing processes, controller 200 may include various subsystems, such as a programmable logic controller (PLC) 202 including computer executable instructions stored in non-volatile memory for controlling imagers 116, lighting units 110, and other elements of the present disclosure as will be discussed in further detail below. Controller 200 may further include various switches such as a vision system switch 204 under the control of PLC 202 for enabling/disabling the imagers 116. The PCL 202 may further comprise a PID control loop and a light sensor for determining and controlling lighting units 110 intensity. Still other componentry is contemplated, including standby systems 206, processing systems 208, and others.

In particular embodiments, imagers 116 are high resolution cameras providing a suitable high resolution image of a portion P of a workpiece. Without intending any limitation, in one embodiment imagers 116 are area scan cameras including CCD sensors and data pre-processing capabilities, such as the BM-500 series of high resolution cameras manufactured by JAI (Shanghai, China).

The light sources 114 may be selected from any suitable light source. In one embodiment, fluorescent lamps are utilized having color temperature 4000k (840 cool white) and providing from a nominal luminous flux of 3050 lumen (lm) to a maximum luminous flux of 3650 lm. In another embodiment, LED lamps are utilized comprising multiple rows of high intensity LEDs, having color temperature about 6500-9000 k, and providing about 4750-6500 lm. In yet another embodiment, LED lamps are utilized having color temperature of about 6500-9000 k and providing about 3150-4290 lm.

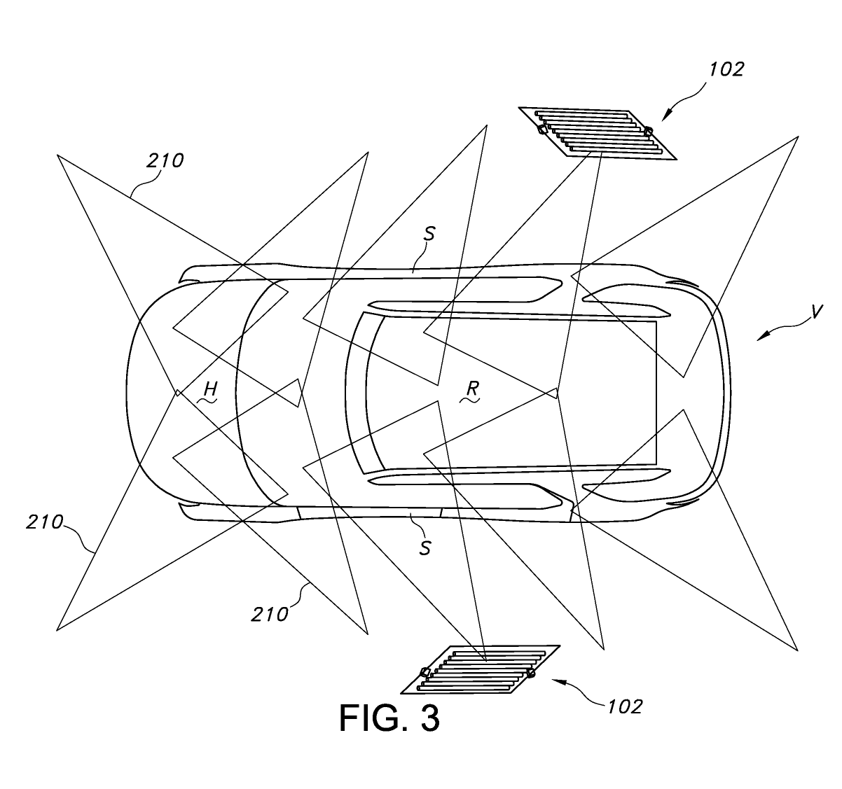

As will be appreciated, inclusion of an adjustable support frame 112 allows adjusting the imaging modules 100 according to particular configurations/orientations of various vehicle configurations that the imaging module 102 may be used to image. This is depicted in FIGS. 2 and 3. With reference to FIG. 2 a pair of independently operating imaging modules 102 are arrayed to obtain images of a portion of a workpiece surface. In the depicted embodiment, each imaging module adjustable support frame 112 is oriented whereby the fields of vision 210 of the imagers 116 overlap on a portion of the hood H and a portion of a roof panel R of a vehicle body V. Of course, as described the position and orientation of the imaging modules 102 may be differently oriented to image different portions of the vehicle V, such as different portions of the hood H and/or roof panel R or the trunk or cargo area C of the vehicle (see FIG. 2), or side panels S of the vehicle body V as shown in FIG. 3.

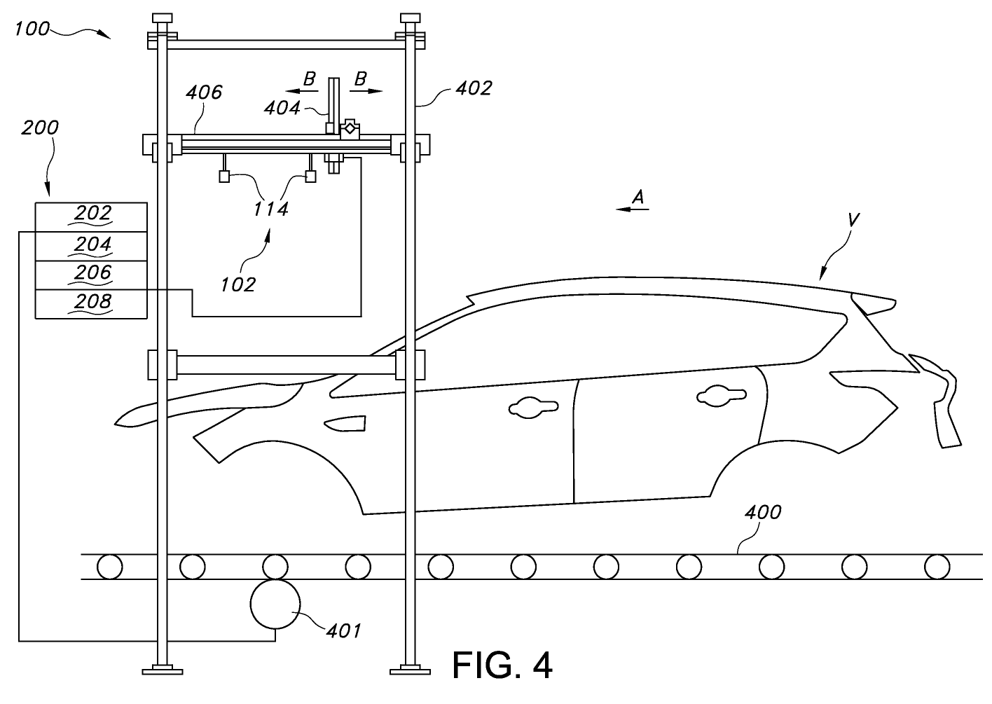

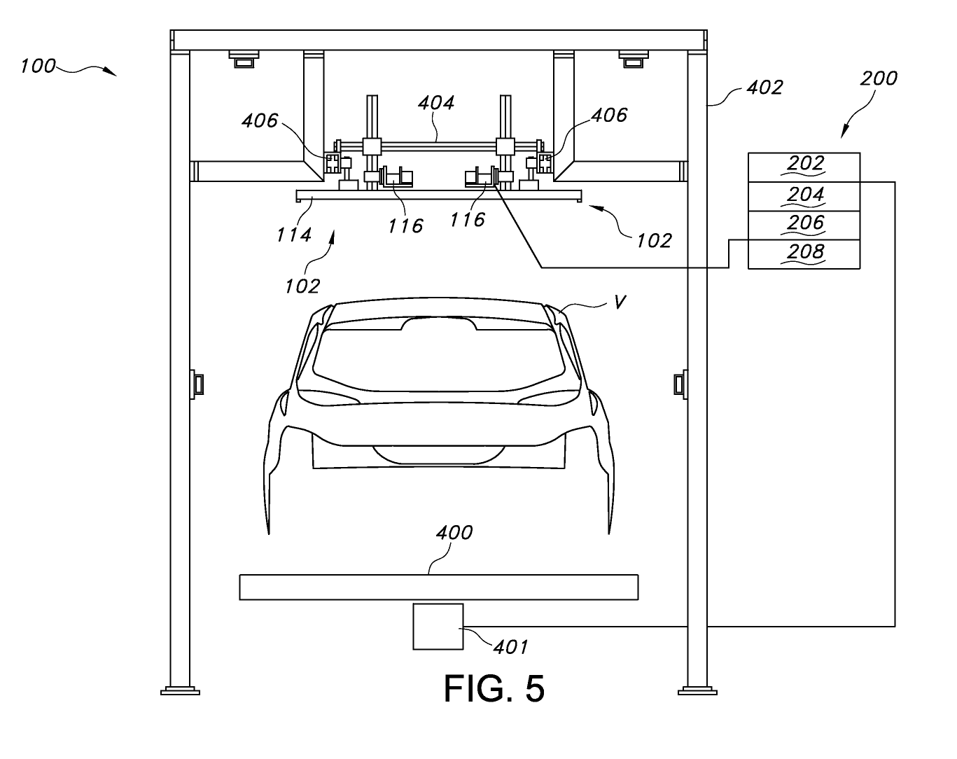

Desirably, the imaging system 100 is adaptable to particular manufacturing facilities. As is known, in the automotive manufacturing setting vehicle components such as pretreated vehicle body units V are transported from one area of the manufacturing facility to another, or into and out of particular areas such as painting areas, sanding areas, etc., by automated means such as a conveyer 400 (see FIG. 4). In the embodiment depicted in FIGS. 4 and 5, imaging system 100 further comprises a frame 402 configured to hold one or more imaging modules 102 as described above. In use, a relative motion is established between a portion of a workpiece to be imaged and the imaging modules 102. As will be appreciated, the speed of this relative motion is unimportant, as any variation may be compensated for by one or more of adjusting an image sampling frequency of the imagers 116 and/or the controller 200, or by the processing speed of the involved processors. The imaging system 100 including frame 402 of the present disclosure is specifically configured such that it may be placed at any desired point along the assembly line, and indeed may be quickly repositioned to a different point along the assembly line as needed.

Because certain embodiments of the imaging system involve calculations requiring knowledge of a position of the vehicle body unit V relative to the imaging modules 102, a position sensor 401 may be included to detect such position, i.e. when the vehicle body unit V is properly positioned for scanning relative to the imaging modules 102, and return data to controller 200. A number of suitable types of position sensors are known in the art for determining a linear position of a body, and are contemplated for use herein.

In one embodiment, the imaging modules 102 may be held in a fixed position by frame 402, whereby vehicle body unit V carried by conveyer 400 passes thereunder (see arrow A). By this motion imparted by conveyer 400, a relative motion is established between an imaged portion of vehicle body unit V and the imaging modules 102 for scanning of a portion of the vehicle body unit V.

In another embodiment as shown in FIG. 4, the imaging modules 102 may be carried by a translatable carrier member 404 of frame 402 configured to translate the imaging modules 102 in a direction (see arrows B) along rails 406. Thus, vehicle body unit V may be conveyed to frame 402 and held stationary thereunder while the imaging modules 102 are translated along rails 406 to scan a portion of the vehicle body unit V to provide the desired relative motion between the imaged portion of vehicle body unit V and the imaging modules 102 for scanning of a portion of the vehicle body unit V.

In still yet another embodiment, the vehicle body unit V may be conveyed through frame 402, and simultaneously as vehicle body unit V is conveyed past frame 402 the imaging modules 102 are translated along rails 406 to scan a portion of the vehicle body unit V. This provides the desired relative motion between the imaged portion of vehicle body unit V and the imaging modules 102 for scanning of a portion of the vehicle body unit V.

Having described various structures contemplated for an imaging system 100, methods for imaging a portion of a workpiece using the imaging system 100 will now be described. The methods allow scanning portions of workpieces such as vehicle body units V held on a moving assembly line within a manufacturing facility, to identify severity and location of defects on the workpiece surface. By the methods, surface defects may be quantified in a desired metric, for example mm² defect/mm² workpiece surface inspected. As noted above, such defects may include without intending any limitation welding residue, sanding residue, scratches, dings, dents, oven residue, dirt specks, fibers/hair, and others.

As a non-limiting example, typically a particular vehicle body type will be manufactured/processed at a manufacturing plant or a site within a manufacturing plant. It is desirable to scan the surfaces of vehicle body units during or after various processing steps, to ascertain whether particular processes are creating surface defects and whether those processes need to be altered to reduce incidence of surface defects. The same vehicle body type may be processed at that site/plant for extended periods of time before switching to a different vehicle body type. Thus, identification of the vehicle body type or style (sedan, SUV, mini-van, etc.) being processed, which would be known ahead of time and input to, e.g., the manufacturing plant conveyer controls, allows positioning or repositioning the imaging modules 102 of the imaging system as and if needed according to the particular body style being processed.

Unlike prior art methods for scanning vehicle body unit surfaces, the presently described methods do not require scanning the entirety of each body panel of the vehicle body. Instead, only a portion of the vehicle body unit is scanned. Indeed, by the described methods only key areas of the vehicle body unit V are scanned to provide sufficient information regarding the existence and position of surface defects (after particular manufacturing processes such as sanding, painting, welding, coating, etc.) to derive a performance rating or cluster graphic for the particular scanned areas. Still further, as will be described the method allows the imaging system of the disclosure to substantially self-calibrate according to the vehicle body type/style being imaged and the speed with which the vehicle body unit is passed through the imaging system.

At a high level, during an inspection cycle of a vehicle body unit V, image data (from images taken as the vehicle body unit passes through the imaging system 100 as described above) are collected from imagers 116 and fused into a complete image of a scanned portion of the body unit. These fused images are compared to “standard” images of the surface having no surface defects, and by this comparison surface defects in the scanned body unit portion are identified. Methods for combining data of multiple images to provide a single fused image are well known in the art.

In one embodiment, standard images of a portion of a vehicle body unit to be inspected are provided by combining high definition CAD or other suitable graphic software drawings of the vehicle body unit portion to be scanned with taken reference images obtained during field calibration of the vehicle body unit portion. Desirably, the method is self-calibrating in that a particular area or portion of a vehicle body unit to be scanned is viewed repeatedly in taken reference images to identify areas of the taken images having dark pixels. Dark pixels are created when a reflection of light passes over a surface defect, causing a momentary shadow. When the areas of the taken reference images having dark pixels reach a predetermined level of repeatability from image to image (in one non-limiting embodiment, using approximately 200 samples), the taken images are combined with the graphic software drawings of the portion to be scanned to provide a standard image of that vehicle body unit portion deemed ready for comparison to fused images taken by the imagers 116 of the described imaging unit 100. Then, areas of dark pixels in the fused images taken by the imagers 116 can reliably be classified as areas of surface defects on the vehicle body unit portions.

In an embodiment, the presently described method is used for dynamic scanning of a portion of a vehicle body unit V, i.e. wherein a relative motion between the portion of the body unit and the imaging module(s) 102 is established as described above. As is known, certain issues must be addressed during such dynamic scanning, including variability (reduced sharpness/motion blurring of images) introduced by vehicle body unit V motion-induced vibration on conveyer 400, variability of the body unit location on the Y-axis, variability in the body unit rotation related to the displacement axis (the direction of conveyance on the conveyer 400), a requirement to determine a current X-axis position of the vehicle body unit, and shape variability and inclination of the portion of the body unit being scanned at each moment of the scanning process.

Advantageously, it has been found that imaging the entire vehicle body unit V is unnecessary to provide sufficient information to adjust manufacturing processes to provide a baseline for system performance to reduce or eliminate surface defects resulting from such processes. Instead, selected vehicle body unit portions are imaged, for example selected areas of the vehicle hood H, roof R, cargo area C, or side panels S (see FIGS. 2-3). The particular areas to be imaged can be selected according to a particular vehicle body style being imaged or to represent areas most viewed by vehicle operators, and provide high repeatability and reproducibility for surface detection of defects.

In embodiments, two areas of the selected vehicle body unit portions are scanned using paired imagers 116 as shown in FIGS. 1-5 to provide more robust statistical results and also to allow for system performance even in the event of temporary failure of one imager. The imagers 116 may be oriented to provide a field of view 210 that is at a close angle to a surface normal vector. In embodiments, two horizontal samples spanning approximately 0.25 m² and two vertical samples spanning approximately 0.25 m² are taken of the vehicle body unit V using imagers 116. As described, to achieve a relative motion between the portion of the body unit and the imaging module(s) 102 may be established by providing a fixed body unit position and translating the imaging modules, by providing a fixed imaging module 102 position and translating the body unit via conveyer 400, or a combination.

To minimize lack of sharpness and motion blurring, it was found necessary to reduce imager 116 exposure time, which necessitated an increase in intensity of light provided by the lighting units 110 to obtain the desired reflectance. This is controlled by including a light sensing meter and PID control loop in PLC 202 as described above. The X-axis position of the vehicle body unit is provided by a position sensor 401 as described above. Moreover, an auxiliary imager (not shown) is optionally included to measure a position of the vehicle body unit from a different position, which information is transformed to the point of view of imagers 116 of the imaging units 102, thus allowing accounting for vehicle body unit displacement variability in matching image frames. Shape variability and inclination of the portion of the vehicle body unit V to be scanned was provided by a lookup table obtained from the graphic software drawings of the vehicle body unit portion.

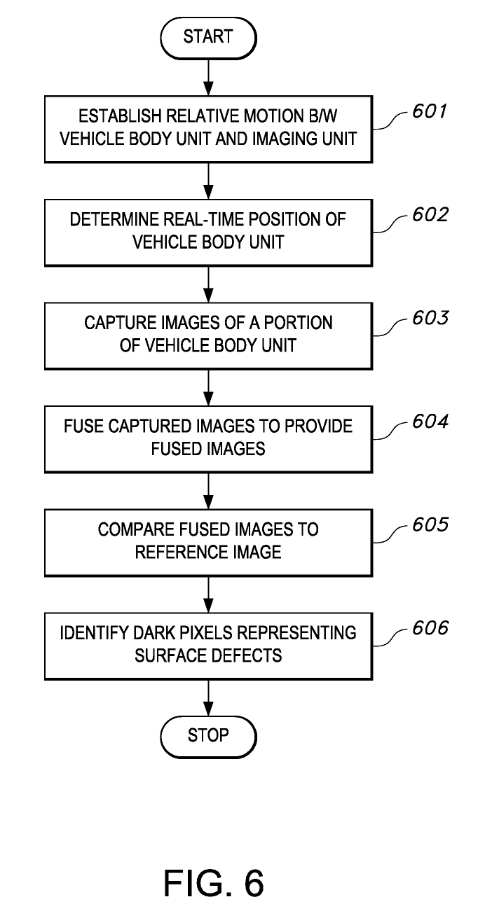

With reference to FIG. 6, in an embodiment the described imaging method for detecting surface defects comprises providing an imaging unit 100 as described above. At step 601, a relative motion is established between a vehicle body unit V and the imaging unit. At step 602, a real-time position of the moving vehicle body unit V on a conveyer 400 is determined at a starting point of imaging acquisition. This is accomplished by one or more of a position sensor 401 and an auxiliary imager providing an additional inspection point. Advantageously, the auxiliary imager allows use of pattern matching tools to identify the portion of the vehicle body unit V to be scanned, i.e. the shape variability and inclination of the portion of the vehicle body unit V to be scanned which is provided by a lookup table obtained from the graphic software drawings of the vehicle body unit portion.

Then, at step 603 the desired portion P of the vehicle body unit V is scanned by imagers 116. As described, a closed loop light intensity control system (a PID control loop and a light sensor for determining and controlling lighting units 110 intensity) is used to allow optimal illumination and maximizing surface defect magnification and identification. As is also described above, one non-limiting example of this step is using paired imagers 116 in imaging modules 102 to obtain images of two portions of a vehicle hood H and a vehicle roof R. Then, at step 604 data of the obtained images are fused to provide fused images. At step 605, the fused images are compared to reference images of the scanned portion of the vehicle body unit, created as described above. Finally, at step 606 dark pixels identified in the fused images are identified as surface defects.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An imaging module for detecting a defect on a workpiece surface, comprising:
a lighting unit comprising an adjustable support frame carrying a plurality of indexing light sources; and
an imaging unit including one or more imagers carried by the support frame.

2. The imaging module of claim 1, wherein the imaging unit includes a pair of imagers disposed on the adjustable support frame to capture one or more images of a portion of the workpiece surface.

3. The imaging module of claim 1, wherein the indexing light sources comprise a plurality of light sources arrayed in a coplanar orientation.

4. The imaging module of claim 1, wherein the support frame is configured to rotate about one or more axes to alter an angle of incidence of light emitted by the lighting unit relative to the workpiece surface.

5. An imaging system for detecting a defect on a workpiece surface, comprising:
one or more independently operating imaging modules; and
a control system comprising one or more processors comprising non-transitory computer-readable instructions for receiving and processing digital data of images captured by the one or more imaging modules to provide a fused image of a portion of the workpiece surface;
wherein the one or more independently operating imaging modules each comprise a lighting unit comprising an adjustable support frame carrying a plurality of indexing light sources and an imaging unit including one or more imagers carried by the support frame.

6. The imaging system of claim 5, wherein the imaging unit includes a pair of imagers disposed on the adjustable support frame to capture one or more images of a portion of the workpiece surface.

7. The imaging system of claim 5, wherein the indexing light sources comprise a plurality of light sources arrayed in a coplanar orientation

8. The imaging system of claim 5, wherein the support frame is configured to rotate about one or more axes to alter an angle of incidence of light emitted by the lighting unit relative to the workpiece surface.

9. The imaging system of claim 5, wherein the control system further includes a positioning imager for determining an initial position of the workpiece surface.

10. The imaging system of claim 5, further including a conveyer for transporting the workpiece past the one or more independently operating imaging modules.

11. The imaging system of claim 10, wherein the control system further includes a workpiece position sensor associated with the conveyer, the position detector being configured for transmitting real-time workpiece position data to the control system.

12. The imaging system of claim 5, wherein the control system further includes one or more light sensors and controllers for determining and controlling an intensity of light emitted from the one or more imaging modules and reflecting from the workpiece surface.

13. The imaging system of claim 5, wherein the one or more independently operating imaging modules are configured for statically scanning the portion of the workpiece surface.

14. The imaging system of claim 5, wherein the one or more independently operating imaging modules are configured for translation over the portion of the workpiece surface.

15. A method for detecting a defect on a workpiece surface, comprising:
scanning a portion of the workpiece surface;
obtaining digital data representing a plurality of images of the scanned portion;
combining the digital data to provide a fused image of the portion of the workpiece surface; and
comparing the fused image to a reference image of the portion of the workpiece surface.

16. The method of claim 15, including accomplishing the scanning by providing a relative motion between the workpiece surface and one or more independently operating imaging modules each comprising a lighting unit including a plurality of indexing light sources held by an adjustable support frame and an imaging unit having one or more imagers disposed on the support frame and oriented to capture one or more images of a portion of the workpiece surface.

17. The method of claim 16, including providing the relative motion by one or both of translating the one or more independently operating imaging modules over the workpiece surface and translating the workpiece surface past the one or more independently operating imaging modules.

18. The method of claim 15, further including a step of identifying dark pixels in the fused image and classifying said dark pixels as defects in the workpiece surface.

19. The method of claim 15, wherein the comparing is to a reference image provided by a high definition CAD drawing combined with digital data of captured images of a reference similar workpiece surface portion.
